(19) United States
(12) Patent Application Publication
(10) Pub. No.: US 2024/0249116 A1
(43) Pub. Date: Jul. 25, 2024

(54) System, Method, and Computer Program Product for Adaptive Feature Optimization During Unsupervised Training of Classification Models

(71) Applicants: Hao Xu, Danville, PA (US); Anurag Tangri, Burlingame, CA (US); Chiranjeet Chetia, Round Rock, TX (US)

(72) Inventors: Hao Xu, Danville, PA (US); Anurag Tangri, Burlingame, CA (US); Chiranjeet Chetia, Round Rock, TX (US)

(73) Assignee: Visa International Service Association, San Francisco, CA (US)

(21) Appl. No.: 18/268,740

(22) PCT Filed: Jan. 20, 2023
(86) PCT No.: PCT/US23/11211

§ 371 Date: Jun. 21, 2023

(51) Int. Cl. G06N 3/0455

(52) U.S. Cl. CPC G06N 3/0455

(57) ABSTRACT

Provided are systems that include a processor to receive a training dataset including a plurality of data records, calculate feature projection errors and classification scores for the plurality of data records using a machine learning model, determine a distribution of features according to feature projection error, apply a downscaling function to each feature value of a feature in a false positive classification distribution to provide a downscaled set of feature values, apply an upscaling function to each feature value of a feature in a false negative classification distribution to provide an upscaled set of feature values, combine the downscaled set of feature values and the upscaled set of feature values with the training dataset to provide an updated training dataset, and train the machine learning model using the updated training dataset to provide an updated trained machine learning model. Methods and computer program products are provided.

### CROSS-REFERENCE TO RELATED APPLICATION

This application is the United States national phase of International Application No. PCT/US2023/011211 filed Jan. 20, 2023, the entire disclosure of which is hereby incorporated by reference in its entirety.

### BACKGROUND

### 1. Technical Field

The present disclosure relates generally to features optimization of machine learning models and, in some non-limiting embodiments or aspects, to systems, methods, and computer program products for adaptive feature optimization of a machine learning model.

### 2. Technical Considerations

Machine learning may be a field of computer science that uses statistical techniques to provide a computer system with the ability to learn (e.g., to progressively improve performance of) a task with data without the computer system being explicitly programmed to perform the task. In some instances, a machine learning model may be developed for a set of data so that the machine learning model may perform a task (e.g., a task associated with a prediction) with regard to the set of data.

A feature of a machine learning model may include an attribute (e.g., a characteristic, a property, and/or the like) shared by all independent units of a dataset on which analysis is to be performed by the machine learning model. The feature may have a value, such as a numerical value, associated with the attribute. In addition, feature importance may refer to a measurement of a contribution that a feature makes to an output of the analysis, such as a prediction or a classification, of the machine learning model. Feature importance may be used to understand behavior of the machine learning model, to detect errors in a dataset to avoid potential failures during implementation of the machine learning model, and to validate a governance process associated with the machine learning model.

In some instances, the importance of a feature of a machine learning model may be obtained by changing a value of the feature (e.g., by removing a value of the feature to provide a value of 0 for the feature in each data record of the dataset or by replacing the values of the feature in each data record of the dataset with a single value, such as a value of 1) in each data record of a dataset to provide a modified dataset, and the machine learning model may be re-trained using the modified dataset. A performance of the re-trained machine learning model for the feature may be determined based on evaluation data.

However, re-training a machine learning model when each feature of a plurality of features in a dataset is changed may take an enormous amount of time. This may be especially true with deep learning models that are known to, in some instances, extend training time and rely on a large number of input features. In addition, the machine learning model may need to be re-trained more than once when each feature of the plurality of features in the dataset is changed to ensure that results are properly obtained.

### SUMMARY

Accordingly, provided are improved systems, devices, products, apparatus, and/or methods for adaptive feature optimization of a machine learning model.

According to some non-limiting embodiments or aspects, provided is a system, comprising: at least one processor programmed or configured to: receive a training dataset comprising a plurality of data records, each data record comprising a plurality of feature values of a plurality of features; calculate a feature projection error for each feature of the plurality of features in each data record of the plurality of data records using a trained machine learning model; calculate a classification score for each data record of the plurality of data records using the trained machine learning model; determine a distribution of features according to feature projection error for each feature of the plurality of features in each data record based on the classification score for each data record, wherein the distribution of features according to feature projection error comprises: a false positive classification distribution of features that comprises a distribution of features according to feature projection error for each feature of the plurality of features in each data record having a false positive classification, and a false negative classification distribution of features that comprises a distribution of features according to feature projection error for each feature of the plurality of features in each data record having a false negative classification; apply a downscaling function to each feature value of a feature having a highest value of projection error in the false positive classification distribution to provide a downscaled set of feature values; apply an upscaling function to each feature value of a feature having a lowest value of projection error in the false negative classification distribution to provide an upscaled set of feature values; combine the downscaled set of feature values and the upscaled set of feature values with the training dataset to provide an updated training dataset; and train the trained machine learning model using the updated training dataset to provide an updated trained machine learning model.

According to some non-limiting embodiments or aspects, provided is a computer-implemented method, comprising: receiving, with at least one processor, a training dataset comprising a first plurality of data records, each data record comprising a plurality of feature values of a plurality of features; calculating, with at least one processor, a feature projection error for each feature of the plurality of features in each data record of a second plurality of data records using a trained machine learning model; calculating, with at least one processor, a classification score for the second plurality of data records using the trained machine learning model; determining, with at least one processor, a distribution of features according to feature projection error for each feature of the plurality of features in a second plurality of data records based on the classification score for each data record of the second plurality of data records, wherein the distribution of features according to feature projection error comprises: a false positive classification distribution of features that comprises a distribution of features according to feature projection error for each feature of the plurality of features in each data record having a false positive classification, and a false negative classification distribution of features that comprises a distribution of features according to feature projection error for each feature of the plurality of features in each data record having a false negative classification; applying, with at least one processor, a downscaling function to each feature value of a feature having a highest value of projection error in the false positive classification distribution to provide a downscaled set of feature values; applying, with at least one processor, an upscaling function to each feature value of a feature having a lowest value of projection error in the false negative classification distribution to provide an upscaled set of feature values; combining, with at least one processor, the downscaled set of feature values and the upscaled set of feature values with the training dataset to provide an updated training dataset; and training, with at least one processor, the trained machine learning model using the updated training dataset to provide an updated trained machine learning model.

According to some non-limiting embodiments or aspects, provided is a computer program product comprising at least one non-transitory computer-readable medium including one or more instructions that, when executed by at least one processor, cause the at least one processor to: receive a training dataset comprising a plurality of data records, each data record comprising a plurality of feature values of a plurality of features; calculate a feature projection error for each feature of the plurality of features in each data record of the plurality of data records using a trained machine learning model; calculate a classification score for each data record of the plurality of data records using the trained machine learning model; determine a distribution of features according to feature projection error for each feature of the plurality of features in each data record based on the classification score for each data record, wherein the distribution of feature projection error comprises: a false positive classification distribution of features that comprises a distribution of features according to feature projection error for each feature of the plurality of features in each data record having a false positive classification, and a false negative classification distribution of features that comprises a distribution of features according to feature projection error for each feature of the plurality of features in each data record having a false negative classification; apply a downscaling function to each feature value of a feature having a highest value of projection error in the false positive classification distribution to provide a downscaled set of feature values; apply an upscaling function to each feature value of a feature having a lowest value of projection error in the false negative classification distribution to provide an upscaled set of feature values; combine the downscaled set of feature values and the upscaled set of feature values with the training dataset to provide an updated training dataset; and train the trained machine learning model using the updated training dataset to provide an updated trained machine learning model.

Further non-limiting embodiments or aspects are set forth in the following numbered clauses:

Clause 1: A system, comprising: at least one processor programmed or configured to: receive a training dataset comprising a plurality of data records, each data record comprising a plurality of feature values of a plurality of features; calculate a feature projection error for each feature of the plurality of features in each data record of the plurality of data records using a trained machine learning model; calculate a classification score for each data record of the plurality of data records using the trained machine learning model; determine a distribution of features according to feature projection error for each feature of the plurality of features in each data record based on the classification score for each data record, wherein the distribution of features according to feature projection error comprises: a false positive classification distribution of features that comprises a distribution of features according to feature projection error for each feature of the plurality of features in each data record having a false positive classification, and a false negative classification distribution of features that comprises a distribution of features according to feature projection error for each feature of the plurality of features in each data record having a false negative classification; apply a downscaling function to each feature value of a feature having a highest value of projection error in the false positive classification distribution to provide a downscaled set of feature values; apply an upscaling function to each feature value of a feature having a lowest value of projection error in the false negative classification distribution to provide an upscaled set of feature values; combine the downscaled set of feature values and the upscaled set of feature values with the training dataset to provide an updated training dataset; and train the trained machine learning model using the updated training dataset to provide an updated trained machine learning model.

Clause 2: The system of clause 1, wherein the at least one processor is further programmed or configured to: determine a performance metric of the updated trained machine learning model; and determine whether a further training procedure for the updated trained machine learning model is necessary based on the performance metric.

Clause 3: The system of clause 1 or 2, wherein the downscaling function comprises a lower bound scalar value and an upper bound scalar value, and wherein the downscaling function is configured such that: a feature value between the lower bound scalar value and the upper bound scalar value is unchanged; a feature value below the lower bound scalar value is changed to the lower bound scalar value; and a feature value above the upper bound scalar value is changed to the upper bound scalar value.

Clause 4: The system of any of clauses 1-3, wherein the upscaling function comprises a lower bound scalar value, an upper bound scalar value, and an intermediate value, and wherein the upscaling function is configured such that: a feature value below the lower bound scalar value and above the upper bound scalar value is unchanged; a feature value between the lower bound scalar value and the intermediate value is changed to the lower bound scalar value; and a feature value between the upper bound scalar value and the intermediate value is changed to the upper bound scalar value.

Clause 5: The system of any of clauses 1-4, wherein the at least one processor is further programmed or configured to: determine a lower bound scalar value and an upper bound scalar value for the downscaling function; and determine a lower bound scalar value, an intermediate value, and an upper bound scalar value for the upscaling function.

Clause 6: The system of any of clauses 1-5, wherein, when determining the lower bound scalar value and the upper bound scalar value for the downscaling function, the at least one processor is programmed or configured to: determine the lower bound scalar value and the upper bound scalar value for the downscaling function based on a Mann-Whitney test; and wherein, when determining the lower bound scalar value, the intermediate value, and the upper bound scalar value for the upscaling function, the at least one processor is programmed or configured to: determine the lower bound scalar value, the intermediate value, and the upper bound scalar value for the upscaling function based on the Mann-Whitney test.

Clause 7: The system of any of clauses 1-6, wherein the trained machine learning model is an unsupervised binary classification machine learning model, and wherein the unsupervised binary classification machine learning model is an autoencoder.

Clause 8: A computer-implemented method, comprising: receiving, with at least one processor, a training dataset comprising a first plurality of data records, each data record comprising a plurality of feature values of a plurality of features; calculating, with at least one processor, a feature projection error for each feature of the plurality of features in each data record of a second plurality of data records using a trained machine learning model; calculating, with at least one processor, a classification score for the second plurality of data records using the trained machine learning model; determining, with at least one processor, a distribution of features according to the feature projection error for each feature of the plurality of features in a second plurality of data records based on the classification score for each data record of the second plurality of data records, wherein the distribution of features according to feature projection error comprises: a false positive classification distribution of features that comprises a distribution of features according to feature projection error for each feature of the plurality of features in each data record having a false positive classification, and a false negative classification distribution of features that comprises a distribution of features according to feature projection error for each feature of the plurality of features in each data record having a false negative classification; applying, with at least one processor, a downscaling function to each feature value of a feature having a highest value of projection error in the false positive classification distribution to provide a downscaled set of feature values; applying, with at least one processor, an upscaling function to each feature value of a feature having a lowest value of projection error in the false negative classification distribution to provide an upscaled set of feature values; combining, with at least one processor, the downscaled set of feature values and the upscaled set of feature values with the training dataset to provide an updated training dataset; and training, with at least one processor, the trained machine learning model using the updated training dataset to provide an updated trained machine learning model.

Clause 9: The computer-implemented method of clause 8, further comprising: determining a performance metric of the updated trained machine learning model; and determining whether a further training procedure for the updated trained machine learning model is necessary based on the performance metric.

Clause 10: The computer-implemented method of clause 8 or 9, wherein the downscaling function comprises a lower bound scalar value and an upper bound scalar value, and wherein the downscaling function is configured such that: a feature value between the lower bound scalar value and the upper bound scalar value is unchanged; a feature value below the lower bound scalar value is changed to the lower bound scalar value; and a feature value above the upper bound scalar value is changed to the upper bound scalar value.

Clause 11: The computer-implemented method of any of clauses 8-10, wherein the upscaling function comprises a lower bound scalar value, an upper bound scalar value, and an intermediate value, and wherein the upscaling function is configured such that: a feature value below the lower bound scalar value and above the upper bound scalar value is unchanged; a feature value between the lower bound scalar value and the intermediate value is changed to the lower bound scalar value; and a feature value between the upper bound scalar value and the intermediate value is changed to the upper bound scalar value.

Clause 12: The computer-implemented method of any of clauses 8-11, further comprising: determining a lower bound scalar value and an upper bound scalar value for the downscaling function; and determining a lower bound scalar value, an intermediate value, and an upper bound scalar value for the upscaling function.

Clause 13: The computer-implemented method of any of clauses 8-12, wherein determining the lower bound scalar value and the upper bound scalar value for the downscaling function comprises: determining the lower bound scalar value and the upper bound scalar value for the downscaling function based on a Mann-Whitney test; and wherein determining the lower bound scalar value, the intermediate value, and the upper bound scalar value for the upscaling function comprises: determining the lower bound scalar value, the intermediate value, and the upper bound scalar value for the upscaling function based on the Mann-Whitney test.

Clause 14: The computer-implemented method of any of clauses 8-13, wherein the trained machine learning model is an unsupervised binary classification machine learning model, and wherein the unsupervised binary classification machine learning model is an autoencoder.

Clause 15: A computer program product comprising at least one non-transitory computer-readable medium including one or more instructions that, when executed by at least one processor, cause the at least one processor to: receive a training dataset comprising a plurality of data records, each data record comprising a plurality of feature values of a plurality of features; calculate a feature projection error for each feature of the plurality of features in each data record of the plurality of data records using a trained machine learning model; calculate a classification score for each data record of the plurality of data records using the trained machine learning model; determine a distribution of features according to feature projection error for each feature of the plurality of features in each data record based on the classification score for each data record, wherein the distribution of feature projection error comprises: a false positive classification distribution of features that comprises a distribution of features according to feature projection error for each feature of the plurality of features in each data record having a false positive classification, and a false negative classification distribution of features that comprises a distribution of features according to feature projection error for each feature of the plurality of features in each data record having a false negative classification; apply a downscaling function to each feature value of a feature having a highest value of projection error in the false positive classification distribution to provide a downscaled set of feature values; apply an upscaling function to each feature value of a feature having a lowest value of projection error in the false negative classification distribution to provide an upscaled set of feature values; combine the downscaled set of feature values and the upscaled set of feature values with the training dataset to provide an updated training dataset; and train the trained machine learning model using the updated training dataset to provide an updated trained machine learning model.

Clause 16: The computer program product of clause 15, wherein the one or more instructions further cause the at least one processor to: determine a performance metric of the updated trained machine learning model; and determine whether a further training procedure for the updated trained machine learning model is necessary based on the performance metric.

Clause 17: The computer program product of clause 15 or 16, wherein the downscaling function comprises a lower bound scalar value and an upper bound scalar value, and wherein the downscaling function is configured such that: a feature value between the lower bound scalar value and the upper bound scalar value is unchanged; a feature value below the lower bound scalar value is changed to the lower bound scalar value; and a feature value above the upper bound scalar value is changed to the upper bound scalar value.

Clause 18: The computer program product of any of clauses 15-17, wherein the upscaling function comprises a lower bound scalar value, an upper bound scalar value, and an intermediate value, and wherein the upscaling function is configured such that: a feature value below the lower bound scalar value and above the upper bound scalar value is unchanged; a feature value between the lower bound scalar value and the intermediate value is changed to the lower bound scalar value; and a feature value between the upper bound scalar value and the intermediate value is changed to the upper bound scalar value.

Clause 19: The computer program product of any of clauses 15-18, wherein the one or more instructions further cause the at least one processor to: determine a lower bound scalar value and an upper bound scalar value for the downscaling function; and determine a lower bound scalar value, an intermediate value, an upper bound scalar value for the upscaling function.

Clause 20: The computer program product of any of clauses 15-19, wherein the trained machine learning model is an unsupervised binary classification machine learning model, and wherein the unsupervised binary classification machine learning model is an autoencoder.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the present disclosure are explained in greater detail below with reference to the exemplary embodiments that are illustrated in the accompanying schematic figures, in which:

FIG. 1 is a diagram of a non-limiting embodiment or aspect of an environment in which systems, devices, products, apparatus, and/or methods, described herein, may be implemented according to the principles of the present disclosure;

FIG. 2 is a diagram of a non-limiting embodiment or aspect of components of one or more devices of FIG. 1;

FIG. 3 is a flowchart of a non-limiting embodiment or aspect of a process for adaptive feature optimization of a machine learning model; and

FIGS. 4A-4G are diagrams of non-limiting embodiments or aspects of an implementation of a process for adaptive feature optimization of a machine learning model.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phrase “based on” may also mean “in response to” where appropriate.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments or aspects, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments or aspects, an acquirer may be a financial institution, such as a bank.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “client” and “client device” may refer to one or more computing devices, such as processors, storage devices, and/or similar computer components, that access a service made available by a server. In some non-limiting embodiments or aspects, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or client devices.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Non-limiting embodiments or aspects of the present disclosure are directed to systems, methods, and computer program products for adaptive feature optimization of a machine learning model. In some non-limiting embodiments or aspects, a feature management system may include at least one processor programmed or configured to receive a training dataset comprising a plurality of data records, each data record comprising a plurality of feature values of a plurality of features; calculate a feature projection error for each feature of the plurality of features in each data record of the plurality of data records using a trained machine learning model; calculate a classification score for each data record of the plurality of data records using the trained machine learning model; determine a distribution of features according to feature projection error for each feature of the plurality of features in each data record based on the classification score for each data record, wherein the distribution of features according to feature projection error comprises: a false positive classification distribution of features that comprises a distribution of features according to feature projection error for each feature of the plurality of features in each data record having a false positive classification, and a false negative classification distribution of features that comprises a distribution of features according to feature projection error for each feature of the plurality of features in each data record having a false negative classification; apply a downscaling function to each feature value of a feature having a highest value of projection error in the false positive classification distribution to provide a downscaled set of feature values; apply an upscaling function to each feature value of a feature having a lowest value of projection error in the false negative classification distribution to provide an upscaled set of feature values; combine the downscaled set of feature values and the upscaled set of feature values with the training dataset to provide an updated training dataset; and train the trained machine learning model using the updated training dataset to provide an updated trained machine learning model. In some non-limiting embodiments or aspects, the trained machine learning model is an unsupervised binary classification machine learning model.

In some non-limiting embodiments or aspects, the feature management system is further programmed or configured to determine a performance metric of the updated trained machine learning model and determine whether a further training procedure for the updated trained machine learning model is necessary based on the performance metric. In some non-limiting embodiments or aspects, the downscaling function comprises a lower bound scalar value and an upper bound scalar value, wherein the downscaling function is configured, such that a feature value between the lower bound scalar value and the upper bound scalar value is unchanged, a feature value below the lower bound scalar value is changed to the lower bound scalar value, and a feature value above the upper bound scalar value is changed to the upper bound scalar value. In some non-limiting embodiments or aspects, the upscaling function comprises a lower bound scalar value, an upper bound scalar value, and an intermediate value, wherein the upscaling function is configured, such that a feature value below the lower bound scalar value and above the upper bound scalar value is unchanged, a feature value between the lower bound scalar value and the intermediate value is changed to the lower bound scalar value, and a feature value between the upper bound scalar value and the intermediate value is changed to the upper bound scalar value.

In some non-limiting embodiments or aspects, the feature management system is further programmed or configured to determine a lower bound scalar value and an upper bound scalar value for both the downscaling function and the upscaling function. In some non-limiting embodiments or aspects, when determining the lower bound scalar value and the upper bound scalar value for both the downscaling function and the upscaling function, the feature management system is programmed or configured to determine a lower bound scalar value and an upper bound scalar value for both the downscaling function and the upscaling function based on the Mann-Whitney test.

In this way, the feature management system may provide for feature optimization of at least one feature of a machine learning model so that the machine learning model may be trained to have increased performance without multiple rounds of re-training the machine learning model for each feature of a plurality of features in a dataset. Further, network resources used to train a machine learning model may be reduced, and the accuracy of a machine learning model may be improved, while simultaneously reducing the runtime for one or more actions performed using the machine learning model based on the increased performance of the machine learning model.

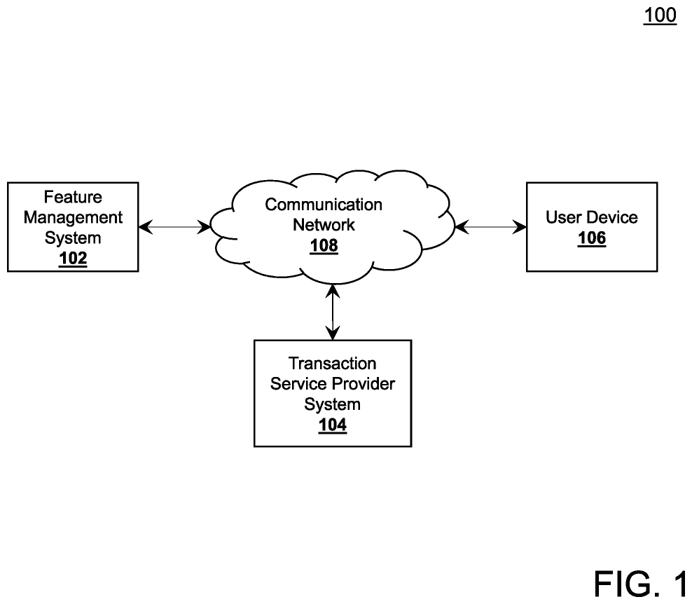

Referring now to FIG. 1, FIG. 1 is a diagram of an example environment 100 in which devices, systems, and/or methods, described herein, may be implemented. As shown in FIG. 1, environment 100 may include feature management system 102, transaction service provider system 104, user device 106, and communication network 108. Feature management system 102, transaction service provider system 104, and/or user device 106 may interconnect (e.g., establish a connection to communicate) via wired connections, wireless connections, or a combination of wired and wireless connections.

Feature management system 102 may include one or more devices configured to communicate with transaction service provider system 104 and/or user device 106 via communication network 108. For example, feature management system 102 may include a server, a group of servers, and/or other like devices. In some non-limiting embodiments or aspects, feature management system 102 may be associated with a transaction service provider system (e.g., may be operated by a transaction service provider as a component of a transaction service provider system, may be operated by a transaction service provider independent of a transaction service provider system, etc.), as described herein. Additionally or alternatively, feature management system 102 may generate (e.g., train, validate, re-train, and/or the like), store, and/or implement (e.g., operate, provide inputs to and/or outputs from, and/or the like) one or more machine learning models. For example, feature management system 102 may generate one or more machine learning models by fitting (e.g., validating) one or more machine learning models against data used for training (e.g., training data). In some non-limiting embodiments or aspects, feature management system 102 may generate, store, and/or implement one or more machine learning models, such as one or more machine learning models that are provided for a production environment (e.g., a real-time or runtime environment used for providing inferences based on data in a live situation). In some non-limiting embodiments or aspects, feature management system 102 may be in communication with a data storage device, which may be local or remote to feature management system 102. In some non-limiting embodiments or aspects, feature management system 102 may be capable of receiving information from, storing information in, transmitting information to, and/or searching information stored in the data storage device.

Transaction service provider system 104 may include one or more devices configured to communicate with feature management system 102 and/or user device 106 via communication network 108. For example, transaction service provider system 104 may include a computing device, such as a server, a group of servers, and/or other like devices. In some non-limiting embodiments or aspects, transaction service provider system 104 may be associated with a transaction service provider system, as discussed herein. In some non-limiting embodiments or aspects, feature management system 102 may be a component of transaction service provider system 104.

User device 106 may include a computing device configured to communicate with feature management system 102 and/or transaction service provider system 104 via communication network 108. For example, user device 106 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106).

Communication network 108 may include one or more wired and/or wireless networks. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

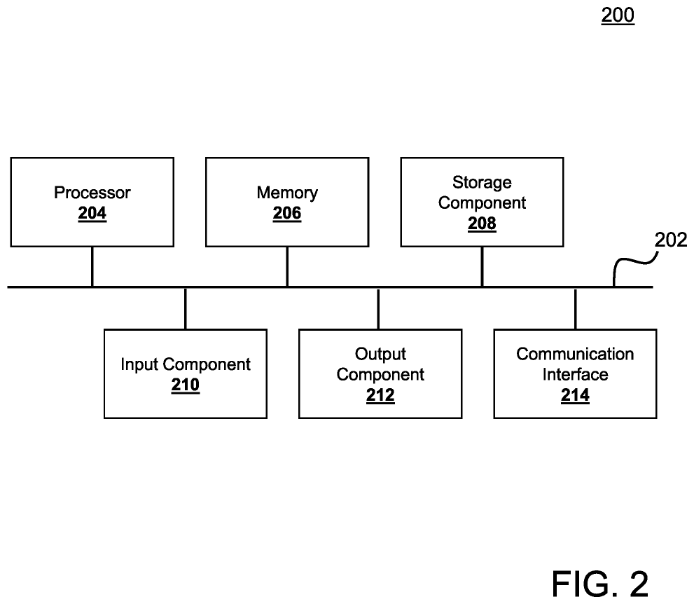

Referring now to FIG. 2, FIG. 2 is a diagram of example components of a device 200. Device 200 may correspond to feature management system 102 (e.g., one or more devices of feature management system 102), transaction service provider system 104 (e.g., one or more devices of transaction service provider system 104), and/or user device 106. In some non-limiting embodiments or aspects, feature management system 102, transaction service provider system 104, and/or user device 106 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

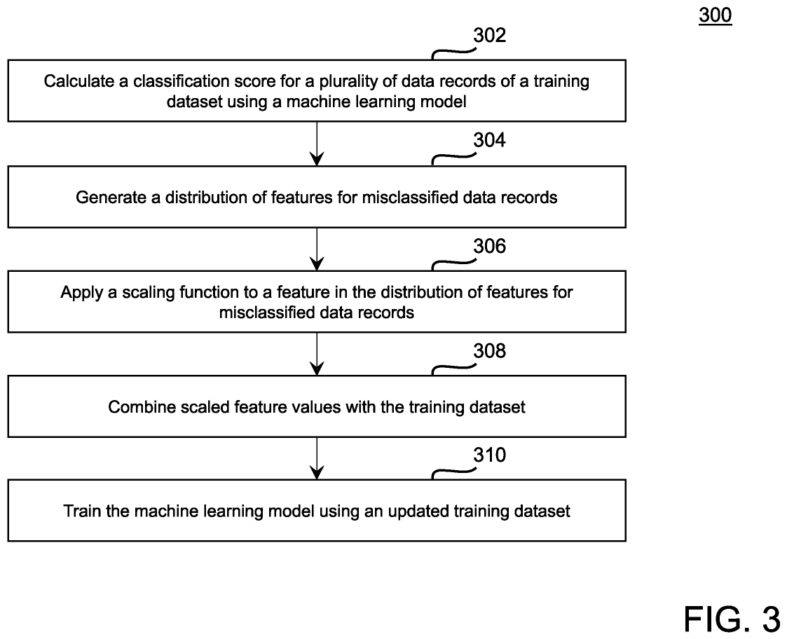

Referring now to FIG. 3, FIG. 3 is a flowchart of a non-limiting embodiment or aspect of a process 300 for adaptive feature optimization of a machine learning model. In some non-limiting embodiments or aspects, one or more of the steps of process 300 may be performed (e.g., completely, partially, etc.) by feature management system 102 (e.g., one or more devices of feature management system 102). In some non-limiting embodiments or aspects, one or more of the steps of process 300 may be performed (e.g., completely, partially, etc.) by another device or a group of devices separate from or including feature management system 102 (e.g., one or more devices of feature management system 102), transaction service provider system 104 (e.g., one or more devices of transaction service provider system 104), and/or user device 106.

As shown in FIG. 3, at step 302, process 300 includes calculating a classification score for a plurality of data records of a training dataset using a machine learning model. For example, feature management system 102 may calculate a classification score for the plurality of data records of a dataset (e.g., a training dataset) using a machine learning model. Each data record may include a plurality of feature values of a plurality of features. In some non-limiting embodiments or aspects, each data record may include an observation value (e.g., an observed value) of each feature of a plurality of features. In some non-limiting embodiments or aspects, feature management system 102 may calculate a classification score for each data record of the plurality of data records using a machine learning model. In some non-limiting embodiments or aspects, the data records may include unlabeled (e.g., may not have a label of a classification, such as a binary classification) data with regard to a potential classification provided by the machine learning model. In some non-limiting embodiments or aspects, the data records may include only unlabeled data.

In some non-limiting embodiments or aspects, the machine learning model may include a trained machine learning model, such as a machine learning model that has been trained on a dataset that is different from the dataset which feature management system 102 may use to calculate the classification score. In some non-limiting embodiments or aspects, the machine learning model may include an unsupervised binary classification machine learning model. For example, the machine learning model may include an unsupervised binary classification machine learning model that has been trained on unlabeled data.

In some non-limiting embodiments or aspects, the machine learning model may be configured to provide an output that includes a prediction regarding an indication of whether an input, such as a data record, is classified in a first group, such as normal, or in a second group, such as abnormal. For example, the machine learning model may be configured to provide an output that includes a prediction (e.g., an output that includes a risk score) regarding an indication of whether an input is classified as normal (e.g., an input is classified as having a low risk) or as risky (e.g., an input is classified as having a high risk).

In some non-limiting embodiments or aspects, the machine learning model may be configured to provide an output that includes a projection of each feature corresponding to each feature of an input. For example, the machine learning model may include an autoencoder that is configured to provide an output vector that includes a projection for each feature (e.g., a projection for each feature corresponding to each feature of an input vector).

In some non-limiting embodiments, feature management system 102 may calculate a feature projection error for each feature of the plurality of features in each data record of the plurality of data records using a trained machine learning model. In one example, the data record may include a plurality of feature values of a plurality of features and feature management system 102 may provide the data record as an input to the machine learning model. Feature management system 102 may generate an output of the machine learning model based on the input, where the output includes a projection value of each feature corresponding to a feature value of each feature of the input. Feature management system 102 may determine a value of projection error of each feature based on the feature values of the plurality of features of the input and the projection values corresponding to the plurality of features of the input. For example, feature management system 102 may compare the feature values of the plurality of features of the input to the projection values for the plurality of features (e.g., the projection values corresponding to the plurality of features of the input) and feature management system 102 may determine the value of projection error of each feature based on a difference between each feature value of the plurality of features of the input and each projection value for the plurality of features.

In some non-limiting embodiments or aspects, feature management system 102 may calculate a classification score for a data record using a machine learning model. For example, feature management system 102 may calculate the classification score of a data record based on the projection error of each feature of the plurality of features of the data record. In such an example, feature management system 102 may calculate the classification score of the data record based on a range of values of projection error. Accordingly, feature management system 102 may assign a first classification score to a data record based on the projection error of each feature of the plurality of features of the data record being included in a first range of values of projection error, a second classification score to a data record based on the projection error of each feature of the plurality of features of the data record being included in a second range of values of projection error, a third classification score to a data record based on the projection error of each feature of the plurality of features of the data record being included in a third range of values of projection error, and so on.

In some non-limiting embodiments or aspects, feature management system 102 may calculate a mean and/or a median of projection error based on the projection error values of each feature of the plurality of features and feature management system 102 may determine the classification score of the data record based on the mean and/or the median of projection error (e.g., based on the mean and/or the median of projection error being included in a range of projection error values).

In some non-limiting embodiments or aspects, a feature value of a feature may correspond to a value of transaction data associated with a payment transaction. For example, the feature value of a feature may correspond to a value of a data field in a record of a payment transaction. In some non-limiting embodiments or aspects, the plurality of features may include one or more features that correspond to transaction data (e.g., a parameter of transaction data, such as a data field in a record of a payment transaction) associated with a payment transaction. For example, the plurality of features may include a transaction amount associated with an amount of the payment transaction (e.g., a cost associated with the payment transaction, a transaction amount, an overall transaction amount, a cost of one or more products involved in the payment transaction, and/or the like), a transaction value associated with a number of payment transactions, a transaction time associated with a time interval at which the payment transaction occurred (e.g., a timestamp that includes a time of day, a day of the week, a date of a month, a month of a year, a predetermined time of day segment such as morning, afternoon, evening, night, and/or the like, a predetermined day of the week segment such as weekday, weekend, and/or the like, a predetermined segment of a year such as first quarter, second quarter, and/or the like), a transaction type of the payment transaction (e.g., an online transaction, a card present transaction, a face-to-face transaction, an electronic commerce indicator, a settlement flag for a payment transaction, and/or the like), an account identifier (e.g., a PAN) of an account involved in the payment transaction, a merchant identifier (e.g., a merchant name) of a merchant involved in the payment transaction, a merchant category code of a merchant involved in the payment transaction, and/or the like.

In some non-limiting embodiments or aspects, the transaction data associated with the payment transactions may include values of a plurality of data fields associated with the payment transactions. The values of the plurality of data fields may include values of one or more transaction amount data fields associated with an amount of the payment transaction (e.g., a cost associated with the payment transaction, a transaction amount, an overall transaction amount, a cost of one or more products involved in the payment transaction, and/or the like), values of one or more transaction time data fields associated with a time interval at which the payment transaction occurred (e.g., a time of day, a day of the week, a date of a month, a month of a year, a predetermined time of day segment such as morning, afternoon, evening, night, and/or the like, a predetermined day of the week segment such as weekday, weekend, and/or the like, a predetermined segment of a year such as first quarter, second quarter, and/or the like), values of one or more transaction type data fields associated with a transaction type of the payment transaction (e.g., an online transaction, a card present transaction, a face-to-face transaction, an electronic commerce indicator, a settlement flag for a payment transaction, and/or the like), and/or the like.

In some non-limiting embodiments or aspects, feature management system 102 may receive the dataset. In some non-limiting embodiments or aspects, feature management system 102 may receive the dataset from an external system, such as an issuer system, a merchant system, a transaction service provider system (e.g., transaction service provider system 104), and/or the like.

In some non-limiting embodiments or aspects, feature management system 102 may perform a feature engineering procedure on the dataset. In some non-limiting embodiments or aspects, the feature engineering procedure may include a numerical transformation procedure (e.g., scaling), a category encoder procedure, a clustering procedure, a procedure to group aggregated values, a principal component analysis procedure, and/or a feature construction procedure. In one example, feature management system 102 may receive an initial dataset with an initial number of features and feature management system 102 may perform the feature engineering procedure (e.g., feature selection), on the initial dataset, to provide a revised dataset that has a revised number of features. In some non-limiting embodiments or aspects, the revised number of features is less than the initial number of features.

As shown in FIG. 3, at step 304, process 300 includes generating a distribution of features for misclassified data records. For example, feature management system 102 may generate a distribution of features for a plurality of misclassified data records (e.g., data records with incorrect classifications). In some non-limiting embodiments or aspects, feature management system 102 may generate a distribution of features according to feature projection error for the plurality of misclassified data records. For example, feature management system 102 may generate a distribution of features according to feature projection error for data records with false positive classifications and false negative classifications. In some non-limiting embodiments or aspects, the distribution of features according to feature projection error may include a histogram that includes a frequency of feature values of a plurality of features included in one or more data records plotted against feature projection error values of the plurality of features. For example, the distribution of features according to feature projection error may include a histogram that includes a frequency of feature values of a plurality of features included in data records with false positive classifications and false negative classifications plotted against feature projection error values of the plurality of features.

In some non-limiting embodiments or aspects, the distribution of features according to feature projection error may include a distribution of features according to feature projection error for each feature of the plurality of features in each data record having a false positive classification (e.g., a false positive classification distribution of features) and a distribution of features according to feature projection error for each feature of the plurality of features in each data record having a false negative classification (e.g., a false negative classification distribution of features).

In some non-limiting embodiments or aspects, feature management system 102 may determine the distribution of features according to feature projection error for each feature of the plurality of features in data records having false positive classification and data records having false negative classifications based on the classification score for each data record. For example, feature management system 102 may determine a projection error value of each feature of the plurality of features based on the feature values of the plurality of features of each data record of the plurality of data records. Feature management system 102 may calculate a classification score of each data record based on the projection error values of the plurality of features of each data record and feature management system 102 may determine a classification (e.g., a classification of normal or a classification of not normal) for each data record based on the classification score of each data record. In some non-limiting embodiments or aspects, feature management system 102 may determine the classification for a data record by comparing the classification score of a data record to a threshold value (e.g., a threshold value of classification score).

In such an example, if the classification score of a data record satisfies the threshold, feature management system 102 may determine the classification for the data record to be not normal. Further, if the classification score of a data record does not satisfy the threshold, feature management system 102 may determine the classification for the data record to be normal. In some non-limiting embodiments or aspects, feature management system 102 may compare the classifications of the plurality of data records to known classifications of the plurality of data records and feature management system 102 may determine a set of data records that have false positive classifications and a set of data records that have false negative classifications.

In the example above, feature management system 102 may generate a distribution of features according to feature projection error values for each feature of the plurality of features in each data record of the set of data records having a false positive classification. Additionally, feature management system 102 may generate a distribution of features according to feature projection error values for each feature of the plurality of features in each data record of the set of data records having a false negative classification.

As shown in FIG. 3, at step 306, process 300 includes applying a scaling function to a feature in the distribution of features for misclassified data records. For example, feature management system 102 may apply a scaling function to a feature in the distribution of features for misclassified data records. In some non-limiting embodiments or aspects, the scaling function may include an upscaling function and/or a downscaling function.

In some non-limiting embodiments or aspects, feature management system 102 may apply a downscaling function to a feature in a distribution of features for false positive classifications. For example, feature management system 102 may apply the downscaling function to a feature in a false positive classification distribution of features (e.g., a distribution of features according to feature projection error for each feature of the plurality of features in each data record having a false positive classification). In some non-limiting embodiments or aspects, feature management system 102 may apply the downscaling function to each feature value of a feature having a high projection error (e.g., a highest value of projection error, a value in highest range of values of projection error, etc.) in the false positive classification distribution. In some non-limiting embodiments or aspects, feature management system 102 may apply a downscaling function to each feature value of a feature having a high projection error in the false positive classification distribution to provide an additional set of feature values (e.g., a downscaled set of feature values).

In some non-limiting embodiments or aspects, the downscaling function may include a plurality of parameters. For example, the downscaling function may include a lower bound scalar value and an upper bound scalar value. In some non-limiting embodiments or aspects, the downscaling function is configured, such that a feature value between the lower bound scalar value and the upper bound scalar value is unchanged, a feature value below the lower bound scalar value is changed to the lower bound scalar value, and a feature value above the upper bound scalar value is changed to the upper bound scalar value.

In some non-limiting embodiments or aspects, feature management system 102 may apply an upscaling function to a feature in a distribution of features for false negative classifications. For example, feature management system 102 may apply the upscaling function to a feature in a false negative classification distribution of features (e.g., a distribution of features according to feature projection error for each feature of the plurality of features in each data record having a false negative classification). In some non-limiting embodiments or aspects, feature management system 102 may apply the upscaling function to each feature value of a feature having a low projection error (e.g., a lowest value of projection error, a value in a lowest range values of projection error, etc.) in the false negative classification distribution of features. In some non-limiting embodiments or aspects, feature management system 102 may apply the upscaling function to each feature value of a feature having a low projection error in the false negative classification distribution to provide an additional set of feature values (e.g., an upscaled set of feature values).

In some non-limiting embodiments or aspects, the upscaling function may include a plurality of parameters. For example, the upscaling function may include a lower bound scalar value, an upper bound scalar value, and an intermediate value. In some non-limiting embodiments or aspects, the upscaling function is configured, such that a feature value below the lower bound scalar value and above the upper bound scalar value is unchanged, a feature value between the lower bound scalar value and the intermediate value is changed to the lower bound scalar value, and a feature value between the upper bound scalar value and the intermediate value is changed to the upper bound scalar value.

In some non-limiting embodiments or aspects, feature management system 102 may determine a parameter of the downscaling function and/or the upscaling function. In one example, feature management system 102 may determine a lower bound scalar value and/or an upper bound scalar value for the downscaling function. In some non-limiting embodiments or aspects, feature management system 102 may determine a lower bound scalar value and/or an upper bound scalar value for the downscaling function based on a Mann-Whitney test (e.g., an application of the Mann-Whitney test, which may include calculating a U-statistic that quantifies a distribution difference between two sample sets, a sample set with a first classification, such as normal and a second classification, such as not normal). Additionally or alternatively, feature management system 102 may determine a lower bound scalar value, an upper bound scalar value, and/or an intermediate value (e.g., an intermediate scalar value) for the upscaling function. For example, feature management system 102 may determine a lower bound scalar value, an upper bound scalar value, and an intermediate value for the upscaling function based on the Mann-Whitney test

In some non-limiting embodiments or aspects, feature management system 102 may determine a parameter of the downscaling function and/or the upscaling function based on a sample set of data records that includes a first subset having a first classification (e.g., normal), which may be denoted as s_{i,Norm}, and a second subset having a second classification (e.g., not normal, risky, etc.), which may be denoted as s_{i,Risk} using the Mann-Whitney test. In some non-limiting embodiments or aspects, feature management system 102 may combine s_{i,Risk} and s_{i,Norm}, and rank the feature values from low to high, such that a lowest value has a rank=1, and the next lowest value has a rank=2, and so on. Feature values that are the same may have a rank that is the same. In some non-limiting embodiments or aspects, feature management system 102 may sum up the ranks for s_{i,Risk} and s_{i,Norm} and calculate a U-statistic according to the following formula:

$$U = min [ {n}_{1} {n}_{2} + 0.5 {n}_{1} ( {n}_{1} + 1 ) - {T}_{1} , {n}_{1} {n}_{2} + 0.5 {n}_{2} ( {n}_{2} + 1 ) - {T}_{2} ]$$

where n₁ and n₂ are a number of data records in s_{i,Risk} and s_{i,Norm}, respectively, and T₁ and T₂ are the summed ranks for s_{i,Risk} and s_{i,Norm}. The U-statistic quantifies the distribution difference between s_{i,Risk} and s_{i,Norm}, such that the smaller the U-statistic, the larger a difference there is between s_{i,Risk} and s_{i,Norm}.

In some non-limiting embodiments or aspects, feature management system 102 may perform a calculation of the U-statistic to minimize the value of the U-statistic using different values of a lower bound scalar value and/or an upper bound scalar value for the downscaling function. In some non-limiting embodiments or aspects, feature management system 102 may perform a calculation of the U-statistic to minimize the value of the U-statistic using different values of a lower bound scalar value, an upper bound scalar value, and/or an intermediate value for the upscaling function.

In some non-limiting embodiments or aspects, feature management system 102 may determine one or more parameters of the downscaling function and/or the upscaling function by determining W(parameter combinations)=[W₁, . . . , W_{M}], as M threshold parameters in the scaling function (e.g., the downscaling function or the upscaling function), and wₙ=[w_{1,n}, . . . , w_{M,n}] as an arbitrary sample set that W can take.

In some non-limiting embodiments or aspects, feature management system 102 may obtain feature values for a first set of data records having a first classification (e.g., risky) and feature values for a second set of data records having a second classification (e.g., normal), which may be denoted as s_{i,Risk}ⁿ and s_{i,Norm}ⁿ, as described in the above example. Every possible set of data records may be determined by a given parameter value combination, wₙ. Using the Mann-Whitney test, feature management system 102 may determine an associated U-statistic: Uᵢⁿ, which quantifies the difference between s_{i,Risk}ⁿ and s_{i,Norm}ⁿ.

Feature management system 102 may iterate over all possible values of wₙ, to provide a value of wₙ that gives the smallest U-statistic (e.g., min(Uᵢ¹, . . . , Uᵢ^{N}). In this way, the value of wₙ that gives the smallest U-statistic may be an optimal parameter value for the downscaling function and/or the upscaling function.

In some non-limiting embodiments or aspects, feature management system 102 may determine one or more parameters of the downscaling function and/or the upscaling function based on a hyperparameter tuning technique, such as grid search, random search, and/or Bayesian optimization.

As shown in FIG. 3, at step 308, process 300 includes combining scaled feature values with the training dataset. For example, feature management system 102 may combine a plurality of scaled feature values with the training dataset. In some non-limiting embodiments or aspects, the plurality of scaled feature values may include a downscaled set of feature values and/or an upscaled set of feature values. In some non-limiting embodiments or aspects, feature management system 102 may combine a downscaled set of feature values and/or an upscaled set of feature values with a training dataset to provide an updated training dataset. In some non-limiting embodiments or aspects, feature management system 102 may combine the downscaled set of feature values and/or the upscaled set of feature values with the training dataset based on applying a scaling function to a feature in a distribution of features for misclassified data records.

As shown in FIG. 3, at step 310, process 300 includes training the machine learning model using an updated training dataset. For example, feature management system 102 may train the machine learning model (e.g., the trained machine learning model) using an updated training dataset that includes a set of downscaled feature values and a set of upscaled feature values. In some non-limiting embodiments or aspects, feature management system 102 may train the machine learning model using the updated training dataset to provide an updated trained machine learning model. In some non-limiting embodiments or aspects, feature management system 102 may train the machine learning model using the updated training dataset based on combining the scaled feature values with the training dataset.

In some non-limiting embodiments or aspects, feature management system 102 may determine a performance metric of the updated trained machine learning model. For example, feature management system 102 may determine one or more performance metrics of the updated trained machine learning model. In some non-limiting embodiments or aspects, feature management system 102 may determine an accuracy metric, a precision metric, a recall metric, and/or the like, of the updated trained machine learning model.

In some non-limiting embodiments or aspects, feature management system 102 may determine whether a further training procedure for the updated trained machine learning model is necessary based on the performance metric. For example, feature management system 102 may determine a value of a performance metric of the updated trained machine learning model and compare the value of the performance metric to a threshold value (e.g., a threshold value of the performance metric). If feature management system 102 determines that the value of the performance metric satisfies the threshold value, feature management system 102 may determine that a further training procedure for the updated trained machine learning model is not necessary. If feature management system 102 determines that the value of the performance metric does not satisfy the threshold value, feature management system 102 may determine that a further training procedure for the updated trained machine learning model is necessary.

In some non-limiting embodiments or aspects, feature management system 102 may perform a further training procedure for the updated trained machine learning model. For example, feature management system 102 may perform a further training procedure for the updated trained machine learning model by repeating a process of calculating a classification score for a plurality of data records of the updated training dataset using the updated trained machine learning model, generating a distribution of features for misclassified data records, applying one or more scaling functions to a feature in the distribution of features for misclassified data records, combining scaled feature values with the updated training dataset to provide a twice updated training dataset, and training the updated trained machine learning model using the twice updated training dataset (e.g., as similarly described in steps 302-310 of process 300). In some non-limiting embodiments or aspects, feature management system 102 may perform a plurality of further training procedures for an updated trained machine learning model as necessary (e.g., until updated trained machine learning model satisfies a threshold value of a performance metric).

In some non-limiting embodiments or aspects, feature management system 102 may receive a request for inference for a production machine learning and feature management system 102 may generate an inference based on the request. In some non-limiting embodiments or aspects, the production machine learning model may include a machine learning model that has been trained and/or validated (e.g., tested) and that may be used to generate inferences (e.g., prediction), such as real-time inferences, runtime inferences, and/or the like. In some non-limiting embodiments or aspects, a production machine learning model may include the updated trained machine learning model.

In some non-limiting embodiments or aspects, the request for inference may be associated with a task for which the production machine learning model may provide an inference. In some non-limiting embodiments or aspects, the request for inference may be associated with financial service tasks. For example, the request for inference may be associated with a token service task, an authentication task (e.g., a 3D secure authentication task), a fraud detection task, and/or the like.

In some non-limiting embodiments or aspects, the request for inference may include runtime input data. In some non-limiting embodiments or aspects, the runtime input data may include a sample of data that is received by a trained machine learning model in real-time with respect to the runtime input data being generated. For example, runtime input data may be generated by a data source (e.g., a customer performing a transaction) and may be subsequently received by the trained machine learning model in real-time. Runtime (e.g., production) may refer to inputting runtime data (e.g., a runtime dataset, real-world data, real-world observations, and/or the like) into one or more trained machine learning models (e.g., one or more trained machine learning models of feature management system 102) and/or generating an inference (e.g., generating an inference using feature management system 102 or another machine learning system).

In some non-limiting embodiments or aspects, runtime may be performed during a phase which may occur after a training phase, after a testing phase, and/or after deployment of the machine learning model into a production environment. During a time period associated with the runtime phase, the machine learning model (e.g., a production machine learning model) may process the runtime input data to generate inferences (e.g., real-time inferences, real-time predictions, and/or the like).

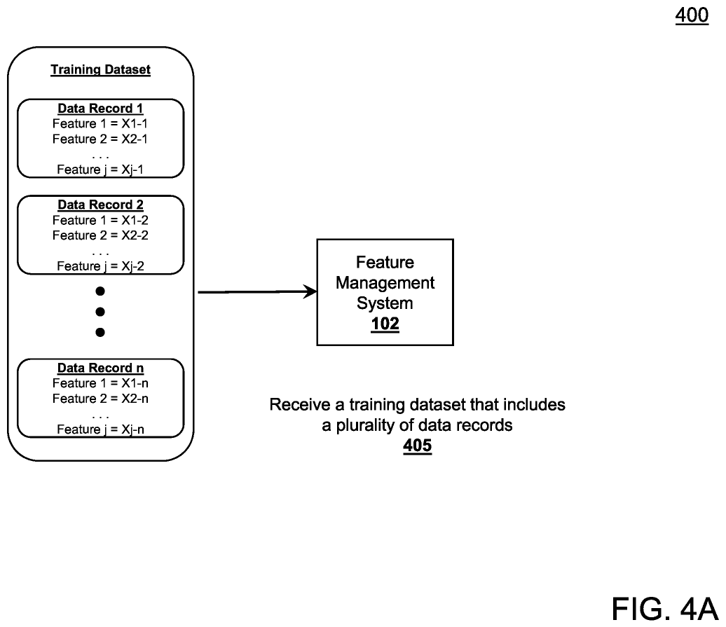

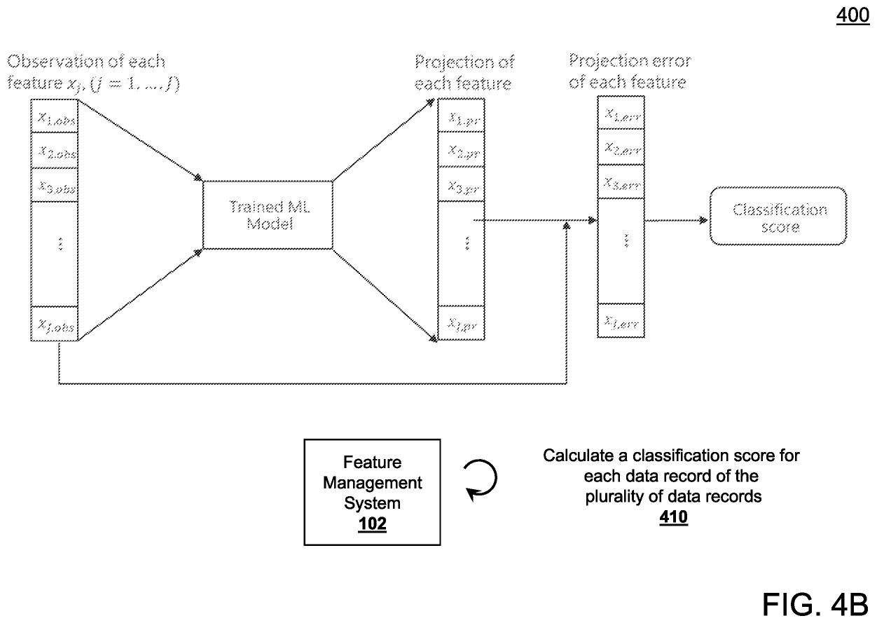

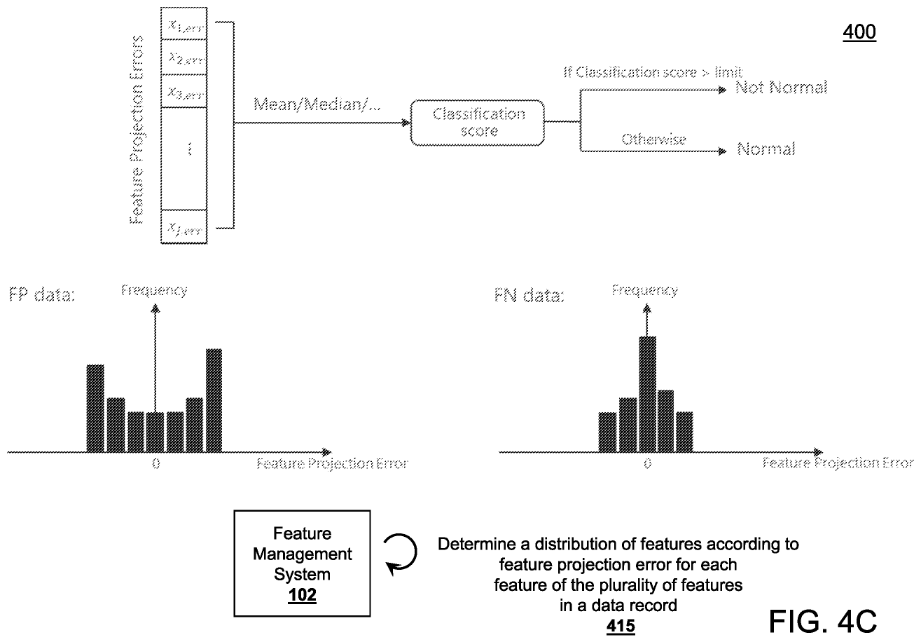

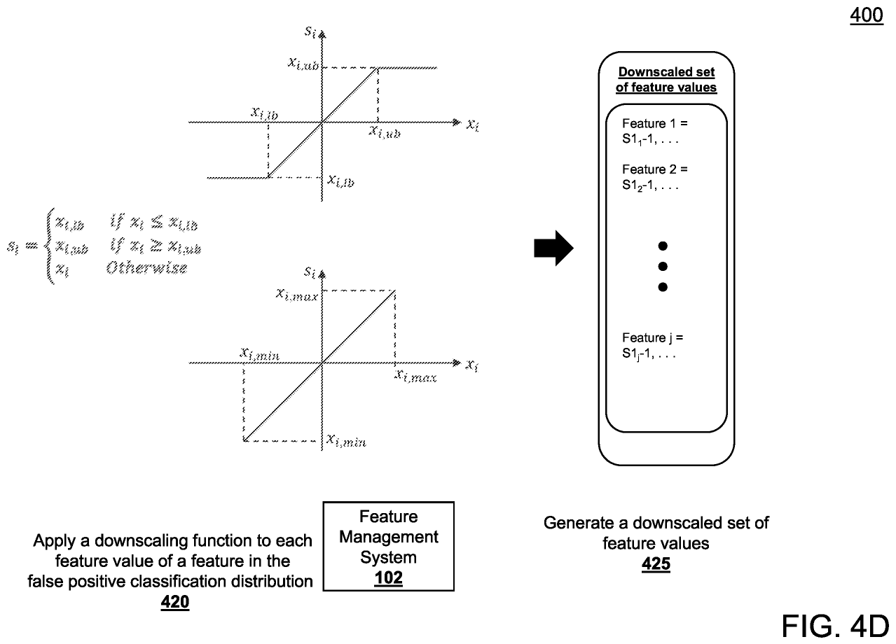

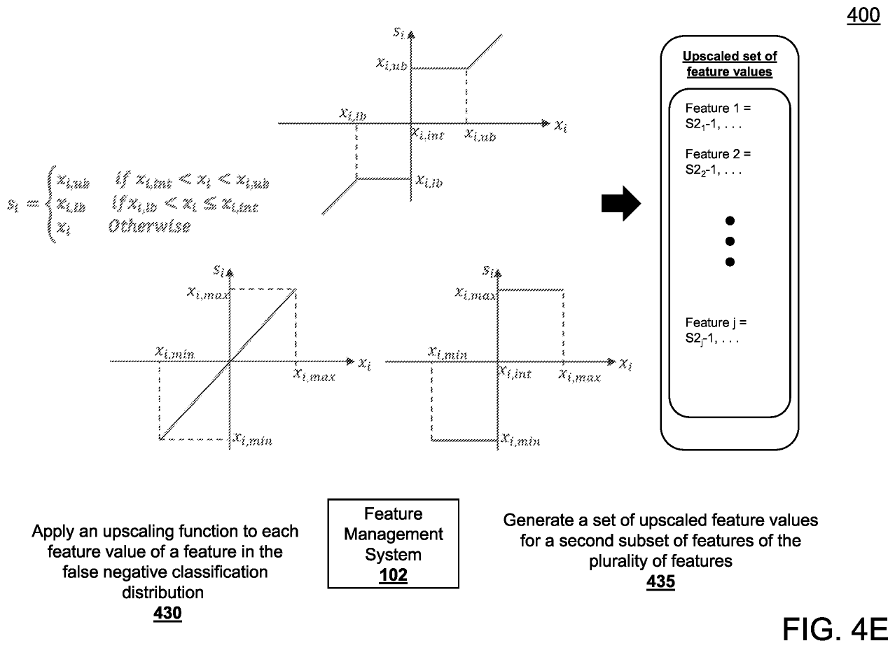

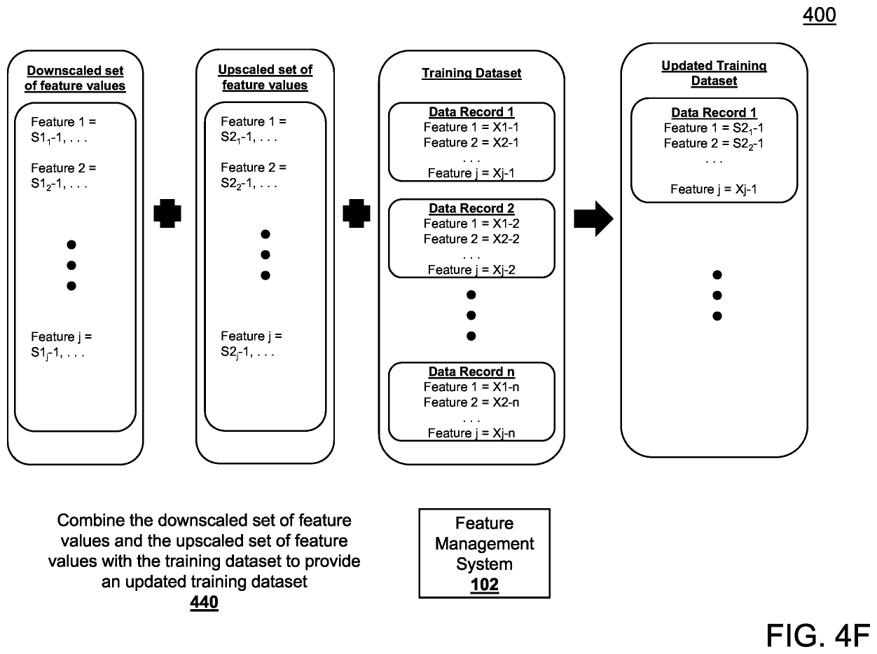

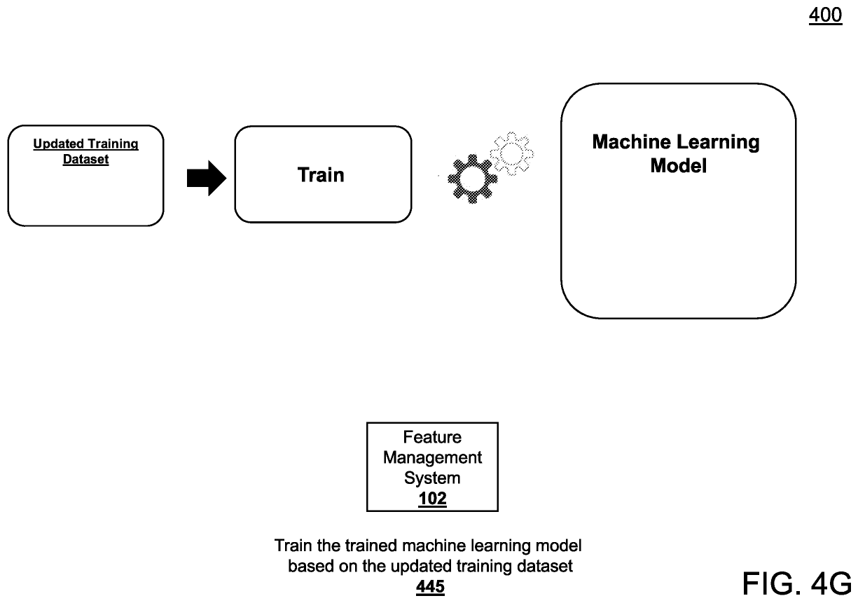

Referring now to FIGS. 4A-4G, FIGS. 4A-4G are diagrams of non-limiting embodiments or aspects of an implementation 400 of a process (e.g., process 300) for adaptive feature optimization of a machine learning model. As illustrated in FIGS. 4A-4G, implementation 400 may include feature management system 102 performing the steps of a process (e.g., a process that is the same or similar to process 300). In some non-limiting embodiments or aspects, one or more of the steps of the process may be performed (e.g., completely, partially, etc.) by another device or a group of devices separate from or including feature management system 102 (e.g., one or more devices of feature management system 102), such as transaction service provider system 104 (e.g., one or more devices of transaction service provider system 104) and/or user device 106. In some non-limiting embodiments or aspects, the steps of the process shown in FIGS. 4A-4G may be associated with a training procedure for a trained machine learning model.

As shown by reference number 405 in FIG. 4A, feature management system 102 may receive a training dataset that includes a plurality of data records. In some non-limiting embodiments or aspects, each data record may include a plurality of feature values of a plurality of features. In some non-limiting embodiments or aspects, each data record may include an observation value (e.g., an observed value) of each feature of a plurality of features. In some non-limiting embodiments or aspects, the data records may include unlabeled (e.g., may not have a label of a classification, such as a binary classification) data with regard to a potential classification provided by a machine learning model.

As shown by reference number 410 in FIG. 4B, feature management system 102 may calculate a classification score for each data record of the plurality of data records. For example, feature management system 102 may calculate a classification score for each data record of the plurality of data records using a trained machine learning model. In some non-limiting embodiments or aspects, the trained machine learning model may include an autoencoder that is configured to provide an output vector that includes a projection for each feature (e.g., a projection for each feature corresponding to each feature of an input vector).

As shown by reference number 415 in FIG. 4C, feature management system 102 may determine a distribution of features according to feature projection error for each feature of the plurality of features in a data record. In some non-limiting embodiments or aspects, feature management system 102 may generate a distribution of features according to feature projection error for data records with false positive classifications and false negative classifications. In some non-limiting embodiments or aspects, the distribution of features according to feature projection error may include a histogram that includes a frequency of feature values of a plurality of features included in one or more data records plotted against feature projection error values of the plurality of features. For example, the distribution of features according to feature projection error may include a histogram that includes a frequency of feature values of a plurality of features included in data records with false positive classifications and false negative classifications plotted against feature projection error values of the plurality of features.

In some non-limiting embodiments or aspects, the distribution of features according to feature projection error may include a distribution of features according to feature projection error for each feature of the plurality of features in each data record having a false positive classification (e.g., a false positive classification distribution of features) and a distribution of features according to feature projection error for each feature of the plurality of features in each data record having a false negative classification (e.g., a false negative classification distribution of features).

As shown by reference number 420 in FIG. 4D, feature management system 102 may apply a downscaling function to each feature value of a feature in the false positive classification distribution. In some non-limiting embodiments or aspects, feature management system 102 may apply the downscaling function to each feature value of a feature having a high projection error (e.g., a highest value of projection error) in the false positive classification distribution. In some non-limiting embodiments or aspects, the downscaling function is configured, such that a feature value between the lower bound scalar value and the upper bound scalar value is unchanged, a feature value below the lower bound scalar value is changed to the lower bound scalar value, and a feature value above the upper bound scalar value is changed to the upper bound scalar value.

As further shown by reference number 425 in FIG. 4D, feature management system 102 may generate a downscaled set of feature values. For example, feature management system 102 may generate a downscaled set of feature values based on applying the downscaling function to each feature value of a feature having a high projection error in the false positive classification distribution.

As shown by reference number 430 in FIG. 4E, feature management system 102 may apply an upscaling function to each feature value of a feature in the false negative classification distribution. In some non-limiting embodiments or aspects, feature management system 102 may apply the upscaling function to each feature value of a feature having a low projection error (e.g., a lowest value of projection error) in the false negative classification distribution of features. In some non-limiting embodiments or aspects, the upscaling function is configured, such that a feature value below the lower bound scalar value and above the upper bound scalar value is unchanged, a feature value between the lower bound scalar value and the intermediate value is changed to the lower bound scalar value, and a feature value between the upper bound scalar value and the intermediate value is changed to the upper bound scalar value.

As further shown by reference number 435 in FIG. 4E, feature management system 102 may generate a set of upscaled feature values for a second subset of features of the plurality of features. For example, feature management system 102 may generate an upscaled set of feature values based on applying the upscaling function to each feature value of a feature having a lowest value of projection error in the false negative classification distribution.

As shown by reference number 440 in FIG. 4F, feature management system 102 may combine the downscaled set of feature values and the upscaled set of feature values with the training dataset to provide an updated training dataset. In some non-limiting embodiments or aspects, feature management system 102 may combine the downscaled set of feature values and the upscaled set of feature values with the training dataset by replacing one or more feature values of a feature with the downscaled set of feature values and/or the upscaled set of feature values.

As shown by reference number 445 in FIG. 4G, feature management system 102 may train (e.g., retrain) the trained machine learning model based on the updated training dataset. In some non-limiting embodiments or aspects, feature management system 102 may determine whether a further training procedure for the updated trained machine learning model is necessary based on the performance metric. For example, feature management system 102 may determine a value of a performance metric of the updated trained machine learning model and compare the value of the performance metric to a threshold value (e.g., a threshold value of the performance metric). If feature management system 102 determines that the value of the performance metric satisfies the threshold value, feature management system 102 may determine that a further training procedure for the updated trained machine learning model is not necessary. If feature management system 102 determines that the value of the performance metric does not satisfy the threshold value, feature management system 102 may determine that a further training procedure for the updated trained machine learning model is necessary.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A system, comprising:
at least one processor programmed or configured to:
receive a training dataset comprising a plurality of data records, each data record comprising a plurality of feature values of a plurality of features;
calculate a feature projection error for each feature of the plurality of features in each data record of the plurality of data records using a trained machine learning model, wherein the trained machine learning model comprises an autoencoder, and wherein, when calculating the feature projection error for each feature of the plurality of features in each data record of the plurality of data records using the trained machine learning model, the at least one processor is programmed or configured to:
provide the data record as an input to the autoencoder;
generate an output of the autoencoder based on the input, where the output includes a projection value of each feature corresponding to a feature value of each feature of the input; and
determine a value of projection error of each feature based on the feature values of the plurality of features of the input and the projection values corresponding to the plurality of features of the input, wherein the value of projection error of each feature is based on a difference between each feature value of the plurality of features of the input and each projection value for the plurality of features;
calculate a classification score for each data record of the plurality of data records using the autoencoder;
determine a distribution of features according to feature projection error for each feature of the plurality of features in each data record based on the classification score for each data record, wherein the distribution of features according to feature projection error comprises:
a false positive classification distribution of features that comprises a distribution of features according to feature projection error for each feature of the plurality of features in each data record having a false positive classification, and
a false negative classification distribution of features that comprises a distribution of features according to feature projection error for each feature of the plurality of features in each data record having a false negative classification;
apply a downscaling function to each feature value of a feature having a highest value of projection error in the false positive classification distribution to provide a downscaled set of feature values;
apply an upscaling function to each feature value of a feature having a lowest value of projection error in the false negative classification distribution to provide an upscaled set of feature values;
combine the downscaled set of feature values and the upscaled set of feature values with the training dataset to provide an updated training dataset; and
train the autoencoder using the updated training dataset to provide an updated autoencoder.

2. The system of claim 1, wherein the at least one processor is further programmed or configured to:
determine a performance metric of the updated trained machine learning model; and
determine whether a further training procedure for the updated trained machine learning model is necessary based on the performance metric.

3. The system of claim 1, wherein the downscaling function comprises a lower bound scalar value and an upper bound scalar value, and wherein the downscaling function is configured such that:
a feature value between the lower bound scalar value and the upper bound scalar value is unchanged;
a feature value below the lower bound scalar value is changed to the lower bound scalar value; and
a feature value above the upper bound scalar value is changed to the upper bound scalar value.

4. The system of claim 1, wherein the upscaling function comprises a lower bound scalar value, an upper bound scalar value, and an intermediate value, and wherein the upscaling function is configured such that:
a feature value below the lower bound scalar value or above the upper bound scalar value is unchanged;
a feature value between the lower bound scalar value and the intermediate value is changed to the lower bound scalar value; and
a feature value between the upper bound scalar value and the intermediate value is changed to the upper bound scalar value.

5. The system of claim 1, wherein the at least one processor is further programmed or configured to:
determine a lower bound scalar value and an upper bound scalar value for the downscaling function; and
determine a lower bound scalar value, an intermediate value, an upper bound scalar value for the upscaling function.

6. The system of claim 5, wherein, when determining the lower bound scalar value and the upper bound scalar value for the downscaling function, the at least one processor is programmed or configured to:
determine the lower bound scalar value and the upper bound scalar value for the downscaling function based on a Mann-Whitney test; and
wherein, when determining the lower bound scalar value, the intermediate value, and the upper bound scalar value for the upscaling function, the at least one processor is programmed or configured to:
determine the lower bound scalar value, the intermediate value, and the upper bound scalar value for the upscaling function based on the Mann-Whitney test.

7. The system of claim 1, wherein the trained machine learning model is an unsupervised binary classification machine learning model, and wherein the unsupervised binary classification machine learning model is an autoencoder.

8. A computer-implemented method, comprising:
receiving, with at least one processor, a training dataset comprising a first plurality of data records, each data record comprising a plurality of feature values of a plurality of features;
calculating, with at least one processor, a feature projection error for each feature of the plurality of features in each data record of a second plurality of data records using a trained machine learning model, wherein the trained machine learning model comprises an autoencoder, and wherein calculating the feature projection error for each feature of the plurality of features in each data record of the plurality of data records using the trained machine learning model comprises:
providing the data record as an input to the autoencoder;
generating an output of the autoencoder based on the input, where the output includes a projection value of each feature corresponding to a feature value of each feature of the input; and
determining a value of projection error of each feature based on the feature values of the plurality of features of the input and the projection values corresponding to the plurality of features of the input, wherein the value of projection error of each feature is based on a difference between each feature value of the plurality of features of the input and each projection value for the plurality of features;
calculating, with at least one processor, a classification score for the second plurality of data records using the autoencoder;
determining, with at least one processor, a distribution of features according to feature projection error for each feature of the plurality of features in a second plurality of data records based on the classification score for each data record of the second plurality of data records, wherein the distribution of features according to feature projection error comprises:
a false positive classification distribution of features that comprises a distribution of features according to feature projection error for each feature of the plurality of features in each data record having a false positive classification, and
a false negative classification distribution of features that comprises a distribution of features according to feature projection error for each feature of the plurality of features in each data record having a false negative classification;
applying, with at least one processor, a downscaling function to each feature value of a feature having a highest value of projection error in the false positive classification distribution to provide a downscaled set of feature values;
applying, with at least one processor, an upscaling function to each feature value of a feature having a lowest value of projection error in the false negative classification distribution to provide an upscaled set of feature values;
combining, with at least one processor, the downscaled set of feature values and the upscaled set of feature values with the training dataset to provide an updated training dataset; and
training, with at least one processor, the autoencoder using the updated training dataset to provide an updated autoencoder.

9. The computer-implemented method of claim 8, further comprising:
determining a performance metric of the updated trained machine learning model; and
determining whether a further training procedure for the updated trained machine learning model is necessary based on the performance metric.

10. The computer-implemented method of claim 8, wherein the downscaling function comprises a lower bound scalar value and an upper bound scalar value, and wherein the downscaling function is configured such that:
a feature value between the lower bound scalar value and the upper bound scalar value is unchanged;
a feature value below the lower bound scalar value is changed to the lower bound scalar value; and
a feature value above the upper bound scalar value is changed to the upper bound scalar value.

11. The computer-implemented method of claim 8,
wherein the upscaling function comprises a lower bound scalar value, an upper bound scalar value, and an intermediate value, and wherein the upscaling function is configured such that:
a feature value below the lower bound scalar value or above the upper bound scalar value is unchanged;
a feature value between the lower bound scalar value and the intermediate value is changed to the lower bound scalar value; and
a feature value between the upper bound scalar value and the intermediate value is changed to the upper bound scalar value.

12. The computer-implemented method of claim 8, further comprising:
determining a lower bound scalar value and an upper bound scalar value for the downscaling function; and
determining a lower bound scalar value, an intermediate value, an upper bound scalar value for the upscaling function.

13. The computer-implemented method of claim 12, wherein determining the lower bound scalar value and the upper bound scalar value for the downscaling function comprises:
determining the lower bound scalar value and the upper bound scalar value for the downscaling function based on a Mann-Whitney test; and
wherein determining the lower bound scalar value, the intermediate value, and the upper bound scalar value for the upscaling function comprises:
determining the lower bound scalar value, the intermediate value, and the upper bound scalar value for the upscaling function based on the Mann-Whitney test.

14. The computer-implemented method of claim 8, wherein the trained machine learning model is an unsupervised binary classification machine learning model, and wherein the unsupervised binary classification machine learning model is an autoencoder.

15. A computer program product comprising at least one non-transitory computer-readable medium including one or more instructions that, when executed by at least one processor, cause the at least one processor to:
receive a training dataset comprising a plurality of data records, each data record comprising a plurality of feature values of a plurality of features;
calculate a feature projection error for each feature of the plurality of features in each data record of the plurality of data records using a trained machine learning model, wherein the trained machine learning model comprises an autoencoder, and wherein the one or more instructions that cause the at least one processor to calculate the feature projection error for each feature of the plurality of features in each data record of the plurality of data records using the trained machine learning model, cause the at least one processor to:
provide the data record as an input to the autoencoder;
generate an output of the autoencoder based on the input, where the output includes a projection value of each feature corresponding to a feature value of each feature of the input; and
determine a value of projection error of each feature based on the feature values of the plurality of features of the input and the projection values corresponding to the plurality of features of the input, wherein the value of projection error of each feature is based on a difference between each feature value of the plurality of features of the input and each projection value for the plurality of features;
calculate a classification score for each data record of the plurality of data records using the autoencoder;
determine a distribution of features according to feature projection error for each feature of the plurality of features in each data record based on the classification score for each data record, wherein the distribution of feature projection error comprises:
a false positive classification distribution of features that comprises a distribution of features according to feature projection error for each feature of the plurality of features in each data record having a false positive classification, and
a false negative classification distribution of features that comprises a distribution of features according to feature projection error for each feature of the plurality of features in each data record having a false negative classification;
apply a downscaling function to each feature value of a feature having a highest value of projection error in the false positive classification distribution to provide a downscaled set of feature values;
apply an upscaling function to each feature value of a feature having a lowest value of projection error in the false negative classification distribution to provide an upscaled set of feature values;
combine the downscaled set of feature values and the upscaled set of feature values with the training dataset to provide an updated training dataset; and
train the autoencoder using the updated training dataset to provide an updated autoencoder.

16. The computer program product of claim 15, wherein the one or more instructions further cause the at least one processor to:
determine a performance metric of the updated trained machine learning model; and
determine whether a further training procedure for the updated trained machine learning model is necessary based on the performance metric.

17. The computer program product of claim 15, wherein the downscaling function comprises a lower bound scalar value and an upper bound scalar value, and wherein the downscaling function is configured such that:
a feature value between the lower bound scalar value and the upper bound scalar value is unchanged;
a feature value below the lower bound scalar value is changed to the lower bound scalar value; and
a feature value above the upper bound scalar value is changed to the upper bound scalar value.

18. The computer program product of claim 15, wherein the upscaling function comprises a lower bound scalar value, an upper bound scalar value, and an intermediate value, and wherein the upscaling function is configured such that:
a feature value below the lower bound scalar value or above the upper bound scalar value is unchanged;
a feature value between the lower bound scalar value and the intermediate value is changed to the lower bound scalar value; and
a feature value between the upper bound scalar value and the intermediate value is changed to the upper bound scalar value.

19. The computer program product of claim 15, wherein the one or more instructions further cause the at least one processor to:
determine a lower bound scalar value and an upper bound scalar value for the downscaling function; and
determine a lower bound scalar value, an intermediate value, an upper bound scalar value for the upscaling function.

20. The computer program product of claim 15, wherein the trained machine learning model is an unsupervised binary classification machine learning model, and wherein the unsupervised binary classification machine learning model is an autoencoder.
